(19) United States
(12) Patent Application Publication
(10) Pub. No.: US 2008/0134279 A1
(43) Pub. Date: Jun. 5, 2008

(54) Frequency Translation Apparatus

(75) Inventors: John Joseph Curtis, Nobleville, IN (US); Andrew Eric Bowyer, Indianapolis, IN (US); Brian David Bajgrowicz, Marion, IN (US)

Correspondence Address: Joseph J. Laks;Thomson Licensing LLC, 2 Independence Way, Patent Operations, PO Box 5312, PRINCETON, NJ, 08543, US

(73) Assignee: THOMSON LICENSING, Boulogne-Billancourt (FR)

(21) Appl. No.: 11/792,205

(22) PCT Filed: Dec. 13, 2005
(86) PCT No.: PCT/US05/44924

§ 371 Date: May 31, 2007

Related U.S. Application Data
(60) Provisional application No. 60/636,038, filed on Dec. 14, 2004.

(51) Int. Cl. H04N 7/16

(52) U.S. Cl. 725/144

(57) ABSTRACT

An architecture and protocol enables signal communications between a frequency translation module and a plurality of decoders within a dwelling. According to an exemplary embodiment, the frequency translation module includes a plurality of inputs operative to receive a plurality of bands of television signals. A plurality of tuners is connected to the inputs. The tuners convert the bands of television signals to a plurality of intermediate frequencies. A controller is operative to receive request commands for the bands of television signals from the decoders. Each of the decoders transmits one of the request commands to the frequency translation module during a separate time slot.

### CROSS REFERENCE TO RELATED APPLICATION

This application claims priority to and all benefits accruing from a provisional application filed in the United States Patent and Trademark Office on Dec. 14, 2004, and there assigned Ser. No. 60/636,038.

### BACKGROUND OF THE INVENTION

1. Field of the Invention

The present invention generally relates to signal communications, and more particularly, to an architecture and protocol for enabling signal communications between a frequency translation apparatus, which may be referred to herein as a frequency translation module (FTM), and an integrated receiver-decoder (IRD) within a dwelling.

2. Background Information

In a satellite broadcast system, one or more satellites receive signals including audio and/or video signals from one or more earth-based transmitters. The satellite(s) amplify and rebroadcast these signals to signal receiving equipment at the dwellings of consumers via transponders that operate at specified frequencies and have prescribed bandwidths. Such a system includes an uplink transmitting portion (i.e., earth to satellite(s)), an earth-orbiting satellite receiving and transmitting portion, and a downlink portion (i.e., satellite(s) to earth).

In dwellings that receive signals from a satellite broadcast system, signal receiving equipment may be used to frequency shift the entire broadcast spectrum of the satellite(s), and frequency stack the resultant output onto a single coaxial cable. However, as the number of satellites within a satellite broadcast system increases, a point will be reached where the total bandwidth required to accommodate all of the satellites will exceed the transmission capability of the coaxial cable. The present invention described herein addresses this and/or other problems.

### SUMMARY OF THE INVENTION

In accordance with an aspect of the present invention, an apparatus is disclosed. According to an exemplary embodiment, the apparatus comprises a plurality of inputs for receiving a plurality of bands of television signals. A plurality of tuning means converts the bands of television signals to a plurality of intermediate frequencies. Control means receives request commands for the bands of television signals from a plurality of decoders, wherein each of the decoders transmits one of the request commands to the apparatus during a separate time slot.

In accordance with another aspect of the present invention, a method for providing television signals via an apparatus is disclosed. According to an exemplary embodiment, the method comprises steps of receiving a plurality of bands of television signals from a plurality of signal receiving elements, converting the bands of television signals to a plurality of intermediate frequencies, and receiving request commands for the bands of television signals from a plurality of decoders, wherein each of the decoders transmits one of the request commands to the apparatus during a separate time slot.

In accordance with another aspect of the present invention, a television signal receiver is disclosed. According to an exemplary embodiment, the television signal receiver comprises a plurality of inputs operative to receive a plurality of bands of television signals. A plurality of tuners is connected to the inputs. Each of the tuners is operative to convert the bands of television signals to a plurality of intermediate frequencies. A controller is operative to receive request commands for the bands of television signals from a plurality of decoders, wherein each of the decoders transmits one of the request commands to the television signal receiver during a separate time slot.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagram showing an exemplary environment for implementing the present invention;

FIG. 2 is a block diagram showing further details of the FTM of FIG. 1 according to an exemplary embodiment of the present invention;

FIG. 3 is a diagram showing “0” and “1” data bits according to an exemplary embodiment of the present invention;

FIG. 4 is a diagram showing a data frame transmission scheme according to an exemplary embodiment of the present invention;

FIG. 5 is a diagram showing an example of data communications using the data frame transmission scheme according to an exemplary embodiment of the present invention;

FIG. 6 is a diagram showing a data frame format according to an exemplary embodiment of the present invention; and

FIG. 7 is a diagram showing an address field format according to an exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

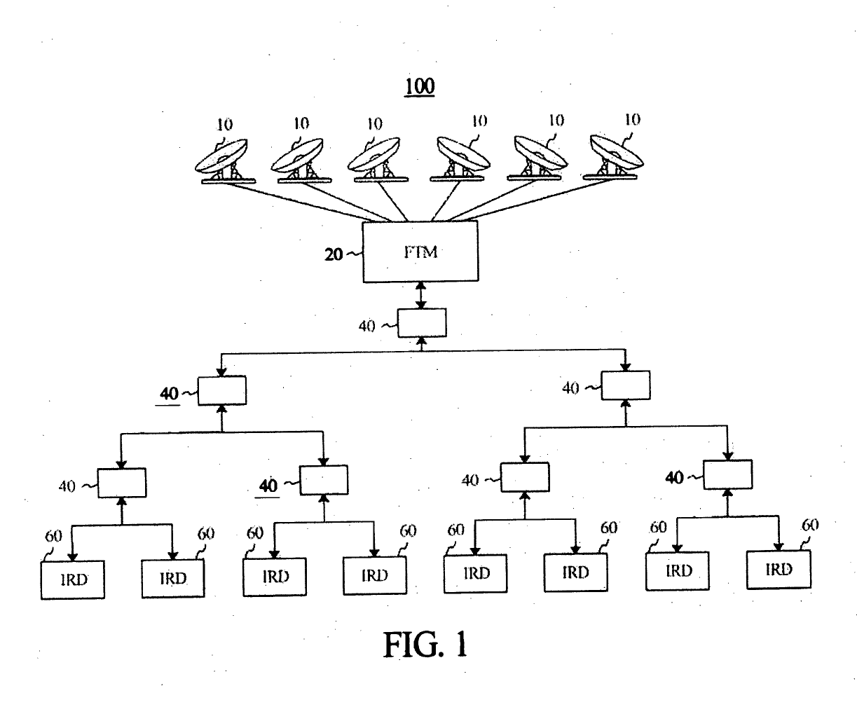

Referring now to the drawings, and more particularly to FIG. 1, a diagram of an exemplary environment 100 for implementing the present invention is shown. Environment 100 of FIG. 1 comprises a plurality of signal receiving means such as signal receiving elements 10, frequency translating means such as FTM 20, a plurality of signal splitting means such as signal splitters 40, and a plurality of signal receiving and decoding means such as IRDs 60. According to an exemplary embodiment described herein, the aforementioned elements of environment 100 are operatively coupled to one another via a transmission medium such as coaxial cable, although other types of transmission mediums may also be used according to the present invention. Environment 100 may for example represent a signal communication network within a given household and/or business dwelling.

Signal receiving elements 10 are each operative to receive signals including audio, video, and/or data signals (e.g., television signals, etc.) from one or more signal sources, such as a satellite broadcast system and/or other type of signal broadcast system. According to an exemplary embodiment, signal receiving element 10 is embodied as an antenna such as a satellite receiving dish, but may also be embodied as any type of signal receiving element.

FTM 20 is operative to receive signals including audio, video, and/or data signals (e.g., television signals, etc.) from signal receiving elements 10, and process the received signals using functions including signal tuning and frequency translation functions to generate corresponding output signals that are provided to IRDs 60 via coaxial cable and signal splitters 40. According to an exemplary embodiment, FTM 20 may communicate with up to 12 IRDs 60 within a single dwelling. For purposes of example and explanation, however, FIG. 1 shows FTM 20 connected to 8 IRDs 60 using simple two-way signal splitters 40. Further exemplary details regarding FTM 20, and its ability to communicate with IRDs 60 will be provided later herein.

Signal splitters 40 are each operative to perform a signal splitting and/or repeating function. According to an exemplary embodiment, signal splitters 40 are each operative to perform a 2-way signal splitting function to facilitate signal communication between FTM 20 and IRDs 60.

IRDs 60 are each operative to perform various signal receiving and processing functions including signal tuning, demodulation and decoding functions. According to an exemplary embodiment, each IRD 60 is operative to tune, demodulate and decode signals provided from FTM 20 via signal splitters 40, and enable aural and/or visual outputs corresponding to the received signals. As will be described later herein, such signals are provided from FTM 20 to IRDs 60 responsive to request commands from IRDs 60, and such request commands may each represent a request for a desired band of television signals. With a satellite broadcast system, each request command may for example indicate a desired satellite and/or a desired transponder. The request commands may be generated by IRDs 60 responsive to user inputs (e.g., via remote control devices, etc.).

According to an exemplary embodiment, each IRD 60 also includes an associated audio and/or video output device such as a standard-definition (SD) and/or high-definition (HD) display device. Such display device may be integrated or non-integrated. Accordingly, each IRD 60 may be embodied as a device such as a television set, computer or monitor that includes an integrated display device, or a device such as a set-top box, video cassette recorder (VCR), digital versatile disk (DVD) player, video game box, personal video recorders (PVR), computer or other device that may not include an integrated display device.

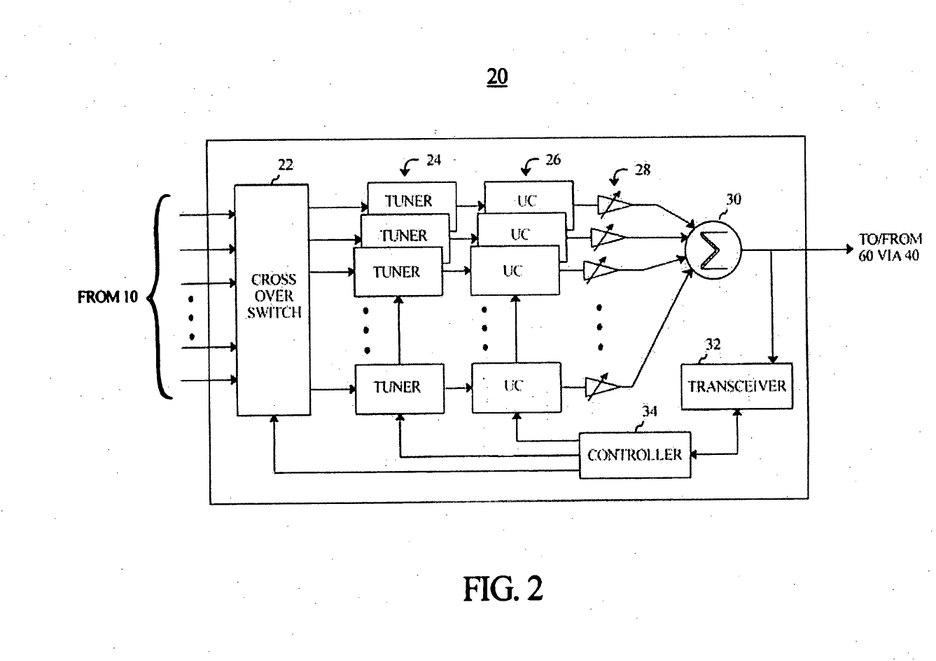

Referring to FIG. 2, a block diagram providing further details of FTM 20 of FIG. 1 according to an exemplary embodiment of the present invention is shown. FTM of FIG. 2 comprises switching means such as cross over switch 22, a plurality of tuning means such as tuners 24, a plurality of frequency converting means such as frequency up converters (UCs) 26, a plurality of amplifying means such as variable gain amplifiers 28, signal combining means such as signal combiner 30, transceiving means such as transceiver 32, and control means such as controller 34. The foregoing elements of FTM 20 may be implemented using integrated circuits (ICs), and one or more elements may be included on a given IC. Moreover, a given element may be included on more than one IC. For clarity of description, certain conventional elements associated with FTM 20 such as certain control signals, power signals and/or other elements may not be shown in FIG. 2.

Cross over switch 22 is operative to receive a plurality of input signals from signal receiving elements 10. According to an exemplary embodiment, such input signals represent various bands of radio frequency (RF) television signals. With a satellite broadcast system, such input signals may for example represent L-band signals, and cross over switch 22 may include an input for each signal polarization used within the system. Also according to an exemplary embodiment, cross over switch 22 selectively passes the RF signals from its inputs to specific designated tuners 24 responsive to control signals from controller 34.

Tuners 24 are each operative to perform a signal tuning function responsive to a control signal from controller 34. According to an exemplary embodiment, each tuner 24 receives an RF signal from cross over switch 22, and performs the signal tuning function by filtering and frequency down converting (i.e., single or multiple stage down conversion) the RF signal to thereby generate an intermediate frequency (IF) signal. The RF and IF signals may include audio, video and/or data content (e.g., television signals, etc.), and may be of an analog signal standard (e.g., NTSC, PAL, SECAM, etc.) and/or a digital signal standard (e.g., ATSC, QAM, QPSK, etc.). The number of tuners 24 included in FTM 20 is a matter of design choice.

Frequency up converters (UCs) 26 are each operative to perform a frequency translation function. According to an exemplary embodiment, each frequency up converter (UC) 26 includes a mixing element and a local oscillator (not shown in FIGS.) that frequency up converts an IF signal provided from a corresponding tuner 24 to a designated frequency band responsive to a control signal from controller 34 to thereby generate a frequency up converted signal.

Variable gain amplifiers 28 are each operative to perform a signal amplification function. According to an exemplary embodiment, each variable gain amplifiers 28 is operative to amplify a frequency converted signal output from a corresponding frequency up converter (UC) 26 to thereby generate an amplified signal. Although not expressly shown in FIG. 2, the gain of each variable gain amplifier 28 may be controlled via a control signal from controller 34.

Signal combiner 30 is operative to perform a signal combining (i.e., summing) function. According to an exemplary embodiment, signal combiner 30 combines the amplified signals provided from variable gain amplifiers 28 and outputs the resultant signals onto a transmission medium such as coaxial cable for transmission to one or more IRDs 60 via signal splitters 40.

Transceiver 32 is operative to enable communications between FTM 20 and IRDs 60. According to an exemplary embodiment, transceiver 32 receives various signals from IRDs 60 and relays those signals to controller 34. Conversely, transceiver 32 receives signals from controller 34 and relays those signals to one or more IRDs 60 via signal splitters 40. Transceiver 32 may for example be operative to receive and transmit signals in one or more predefined frequency bands.

Controller 34 is operative to perform various control functions. According to an exemplary embodiment, controller 34 receives request commands for desired bands of television signals from IRDs 60. As will be described later herein, each IRD 60 may transmit its request command to FTM 20 during a separate time slot that is assigned by controller 34. With a satellite broadcast system, a request command may indicate a desired satellite and/or a desired transponder that provides a desired band of television signals. Controller 34 enables signals corresponding to the desired bands of television signals to be transmitted to corresponding IRDs 60 responsive to the request commands.

According to an exemplary embodiment, controller 34 provides various control signals to cross over switch 22, tuners 24, and frequency up converters (UCs) 26 that cause the signals corresponding to the desired bands of television signals to be transmitted to IRDs 60 via a transmission medium such as coaxial cable. Controller 34 also provides acknowledgement responses to IRDs 60 responsive to the request commands which indicate the frequency bands (e.g., on the coaxial cable, etc.) that will be used to transmit the signals corresponding to the desired bands of television signals to IRDs 60. In this manner, controller 34 may allocate the available frequency spectrum of the transmission medium (e.g., coaxial cable, etc.) so that all IRDs 60 can receive desired signals simultaneously.

Hereinafter, a protocol for communications between FTM 20 and IRDs 60 according to an exemplary embodiment of the present invention will be described.

According to an exemplary embodiment, the physical layer may be based on the digital satellite equipment control (DiSEqC) 2.0 bus specification, but is preferably modulated at 1 to 8 MHz rather than 22 kHz. The exact modulation frequency used in practice is matter of design choice based on several factors, including the typical attenuation through signal splitters 40. For purposes of example and explanation, the remainder of this document will refer to a modulation frequency of 1 MHz.

According to an exemplary embodiment, FTM 20 must tolerate voltages up to 20 volts from IRDs 60 (i.e., not suffer catastrophic failures) to retain compatibility with inadvertent 13/18 volt signaling levels. The nominal 1 MHz signaling amplitude is 650 mV (±250 mV) peak-to-peak. To accommodate tolerances and voltage drops in the coaxial cable, FTM 20 should respond to amplitudes down to approximately 300 mV (±100 mV). The maximum recommended amplitude to be applied to the coaxial cable network is 1 volt peak-to-peak.

According to an exemplary embodiment, FTM 20 and IRDs 60 should avoid injecting “noise” or spurious signals onto the coaxial cable network. However, it is recognized that some disturbance may occur on a cable which carries both power and data signals. Therefore, it is recommended that transceiver 32 of FTM 20 should not lead to detection of signals (at any frequency) having amplitude of less than 100 mV peak-to-peak (either cyclical or “spikes”). To facilitate transmission of a 1 MHz signal, it is preferred that the total load capacitance at the far end of the coaxial cable network not exceed 250 nF (0.25 mF). FTM 20 and IRDs 60 should not load the coaxial cable network by typically more than 100 nF, although a much lower value is preferred.

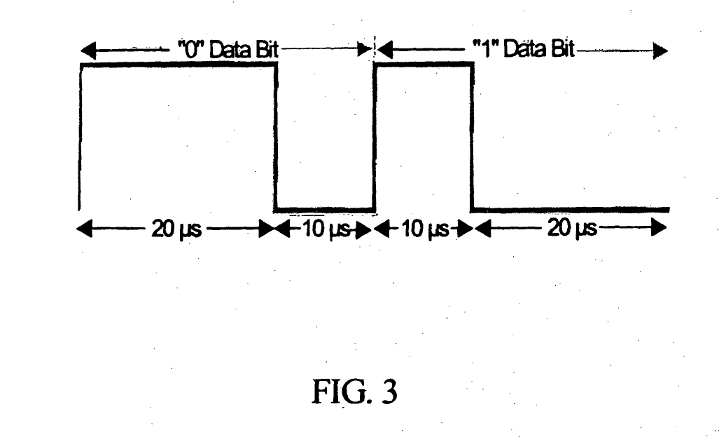

According to an exemplary embodiment, the physical layer uses base band timings of 10 μs (±1 μs) for a one-third bit pulse width modulation (PWM) coded signal period on a nominal 1 MHz (±10%) carrier. FIG. 3 is a diagram showing “0” and “1” data bits according to an exemplary embodiment of the present invention. In particular, FIG. 3 shows a 1 MHz time envelope for each bit transmitted, with nominally 20 cycles for a “0” data bit and 10 cycles for a “1” data bit.

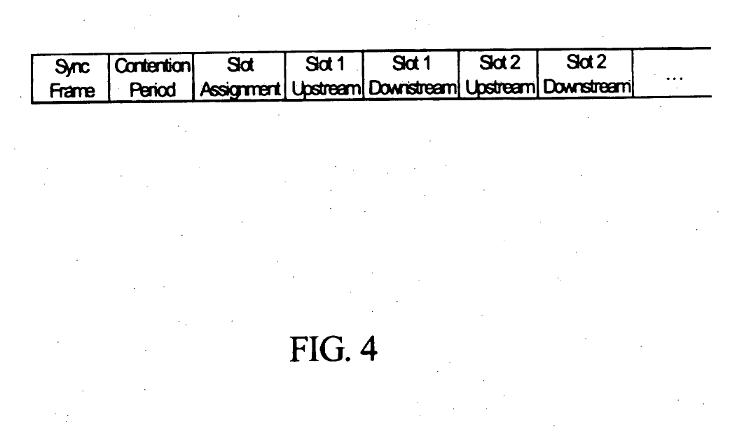

According to an exemplary embodiment, communication between FTM 20 and IRDs 60 uses a time division multiple access (TDMA) scheme with FTM 20 serving as the local network clock. FIG. 4 is a diagram showing a data frame transmission scheme according to an exemplary embodiment of the present invention. As indicated in FIG. 4, FTM 20 begins the TDMA sequence by transmitting a synchronization (“sync”) frame followed by a broadcast contention period for new IRDs 60 to join the network. During the contention period, an IRD 60 must detect the presence of another transmission before it can transmit a slot assignment request frame to FTM 20. FTM 20 responds to new IRDs 60 joining the network in the slot assignment period following the contention period, as indicated in FIG. 4. The minimum contention period is preferably equivalent to two bits of time (e.g., 60 μs) if no IRD 60 chooses to transmit during this period.

According to an exemplary embodiment, contention resolution is based on a truncated binary exponential back-off method, such as defined in section 4.2.3.2.5 of IEEE 802.3. According to this method, an IRD 60 randomly selects a number within a back-off window of, for example, 0 to 12 attempts. This random value indicates the number of contention transmission opportunities which the IRD 60 must defer before transmitting. As an example, consider an IRD 60 whose back-off window is 0 to 12 and that randomly selects the number 5. In this case, the IRD 60 must defer a total of 5 contention transmission opportunities.

As indicated in FIG. 4, IRDs 60 wait for a slot assignment from FTM 20 after a contention transmission. Once a slot assignment is received, the contention resolution is complete. According to an exemplary embodiment, an IRD 60 determines that the contention transmission was lost when two slot assignment periods pass without receiving a slot assignment from FTM 20, or when the slot assignment period contains a collision detected frame indicating a frame collision. In this case, the IRD 60 randomly selects a number within its back-off window and repeats the deferring process described above. This re-try process continues until the maximum number of retries (e.g., 12) has been reached, at which time the payload data unit (PDU) must be discarded.

According to an exemplary embodiment, a valid IRD 60 that has joined the network must transmit upstream to FTM 20 in its assigned slot, and FTM 20 responds to the IRD 60 in the following downstream slot, as indicated in FIG. 4. In this manner, frame collisions on the coaxial cable network can be avoided since each IRD 60 transmits signals during a separate time slot. It is preferred that all IRDs 60 listen to all transmissions on the network. However, if an IRD 60 cannot hear a transmission from another IRD 60, it will generally detect FTM 20's response to that IRD 60. FTM 20 preferably responds to an IRD 60's transmitted frame within 1 μs. The next valid IRD 60 then begins transmission of its frame within 1 μs of the end of FTM 20's response to the previous IRD 60. Data frames transmitted by FTM 20 and IRDs 60 are variable length up a maximum frame length of 70 bytes, although the average frame lengths may be much smaller (e.g., 16 bytes).

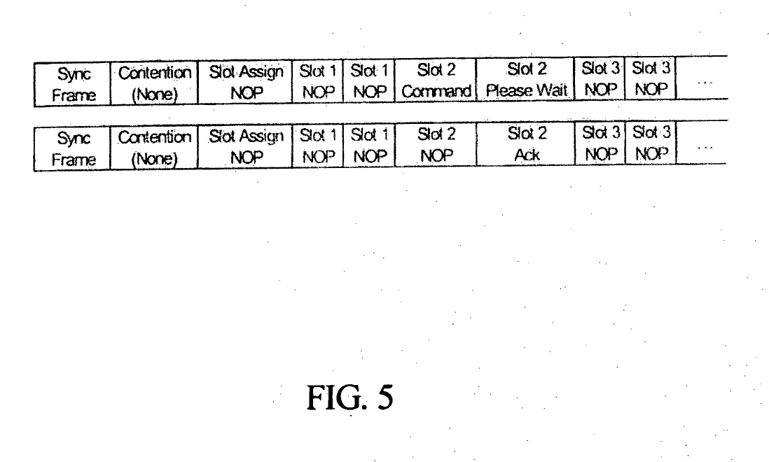

According to an exemplary embodiment, an IRD 60 with an assigned slot must always transmit a frame during its slot. If an IRD 60 has no payload data to send, it transmits a no operation (NOP) frame. FTM 20 always transmits a response to an IRD 60. FTM 20 transmits a please wait frame if it cannot respond immediately to a request, or a NOP frame if no response is needed. FIG. 5 is a diagram showing an example of data communications using the data frame transmission scheme according to an exemplary embodiment of the present invention. In particular, FIG. 5 shows an example with 3 valid IRDs 60 where the IRD 60 assigned to upstream time slot 2 sends a command to FTM 20. In this example, FTM 20 is unable to respond within 10 μs so it transmits a please wait frame. Within the completion of a full carousel, FTM 20 has completed the requested function and sends an acknowledgement response frame to the appropriate IRD 60 in the downstream time slot 2. FTM 20 may also serve as the router/repeater for the network.

According to an exemplary embodiment, there are various different types of commands that may be communicated between FTM 20 and IRDs 60. Below are some exemplary types of commands that may be used according to principles of the present invention. These commands are examples only, and other types of data frames may also be used. The commands below could for example be implemented as fixed length messages.

1. Slot assignment request: This command is used by IRDs 60 to request a time slot assignment from FTM 60.

2. Slot assignment response: This command is used by FTM 20 to assign a time slot to an IRD 60 in response to a slot assignment request. As previously indicated herein, each IRD 60 has its own dedicated upstream and downstream time slots (see FIGS. 4 and 5) in which it transmits commands to and receives commands from FTM 20, respectively.

3. Acknowledgement (Ack) response: This command is used by FTM 20 to acknowledge receipt of a command.

4. Collision detected response: This command is used by FTM 20 to indicate that a collision has been detected on the network.

5. No Acknowledgement (Nack) response: This command is used by FTM 20 to indicate that a request has not been identified/acknowledged.

6. No operation (NOP): This command is used by FTM 20 and IRDs 60 to indicate that no response is needed.

7. Please wait response: This command is used by FTM 20 to indicate that it cannot immediately respond to a request.

8. Channel request: This command is used by IRDs 60 to request signals (e.g., television signals, etc.) in a particular frequency band. With a satellite broadcast system, the requested signals may for example correspond to a particular satellite and/or transponder. FTM 20's acknowledgement response to this command indicates a frequency band (e.g., on the coaxial cable, etc.) that will be used to provide the requested signals to the particular IRD 60 making the request.

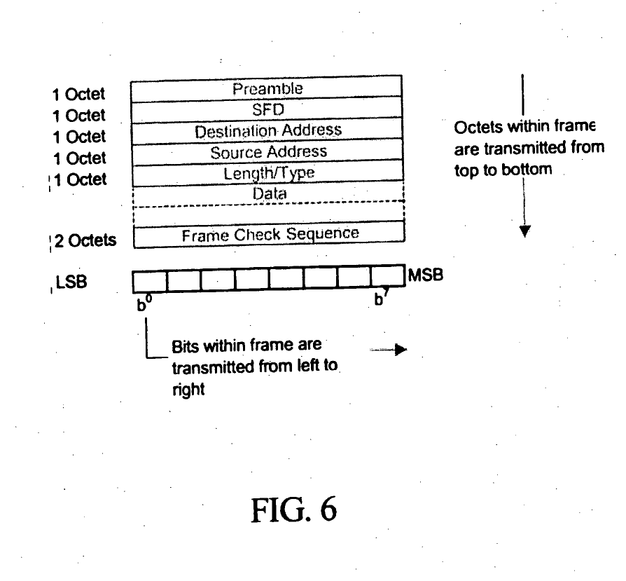

According to an exemplary embodiment, data link layer frames are modeled after IEEE 802.3 frames. FIG. 6 is a diagram showing a data frame format according to an exemplary embodiment of the present invention. As indicated in FIG. 6, an individual data frame includes 7 fields, namely: a preamble field, a start frame delimiter (SFD) field, a destination address field, a source address field, a length/type field, a data field, and a frame check sequence field. Of these 7 fields, all are of fixed size except for the data field, which may contain an integer number of octets between minimum and maximum values that are selected as a matter of design choice. Minimum and maximum frame size limits may for example refer to that portion of the data frame from the destination address field through the frame check sequence field, inclusive. As indicated in FIG. 6, the octets of a data frame are transmitted from top to bottom, and the bits of each octet are transmitted from left to right.

According to an exemplary embodiment, the aforementioned fields of a data frame shown in FIG. 6 are defined as follows.

1. Preamble field: This is a one-octet field having a sequence of “10101010” that is used to establish synchronization on the network among FTM 20 and IRDs 60.

2. SFD field: This is a one-octet field immediately following the preamble field and has a sequence of “10101011” to indicate the start of a frame.

3. Destination address field: This is a one-octet field that specifies the destination addressee(s) for which the frame is intended. As will be described later herein, the destination address field may include an individual or multicast (including broadcast) address.

4. Source address field: This is a one-octet field that specifies the address from which a frame was initiated.

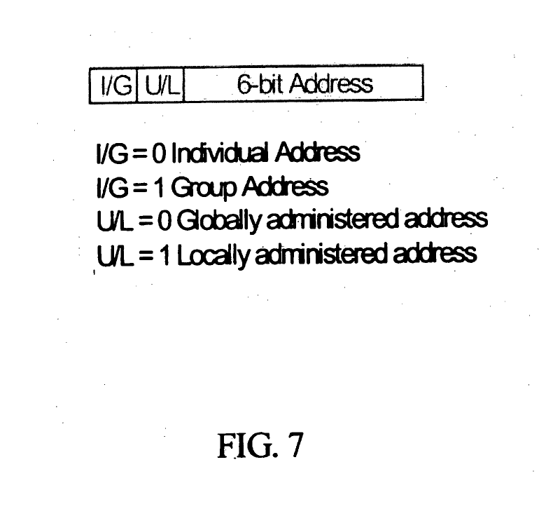

Further details of the destination and source address fields according to an exemplary embodiment of the present invention will now be provided. FIG. 7 is a diagram showing an address field format according to an exemplary embodiment of the present invention.

The destination and source address fields are each 8 bits in length and each octet of each address field may be transmitted least significant bit (LSB) first. The first bit (i.e., the LSB) is used in the destination address field as an address type designation bit to identify the destination address as either an individual address or a group address. An individual address is an address associated with a particular station (i.e., FTM 20, IRD 60, etc.) on the network. Conversely, a group address is a multi-destination address associated with one or more stations on the network. According to an exemplary embodiment, there are at least 2 different types of group addresses, including a multicast address and a broadcast address. A multicast address is an address associated by higher-level convention with a group of logically related stations. A broadcast address is a distinguished, predefined multicast address that always denotes the set of all stations on the network.

In the destination address field, if the first bit is “0,” this indicates an individual address. If the first bit is “1,” this indicates that the destination address field contains a group address that identifies none, one or more, or all of the stations connected to the network. In the source address field, the first bit (i.e., the LSB) is reserved and set to “0.” The second bit of the destination and source address fields is used to distinguish between locally or globally administered addresses. For globally administered (or U, universal) addresses, the second bit is set to “0.” If an address is to be assigned locally, the second bit is set to “1.” Note that for a broadcast address, the second bit is also set to “1.” For communications between FTM 20 and IRDs 60, the second bit is set to “1.” According to an exemplary embodiment, all “1's” in the destination address field is predefined to be the broadcast address. This group includes all stations actively connected to the network and is used to broadcast to all the active stations on the network. All stations are able to recognize the broadcast address, although it is not necessary that a station be capable of generating the broadcast address.

The remaining six bits of the destination and source address fields are used to represent the transmission slot assigned to the particular IRD 60. FTM 20 is the network router/repeater and is assigned the value “0x0.” Values 1-12 are reserved for the service provider within each IRD 60. The service provider may chose to aggregate modem information from all IRDs 60. Each IRD 60 could transmit this information (e.g., pay-per-view billing information) to a single IRD 60 which will combine this modem information with its modem information and then transmit this aggregated information to the service provider via a communication link such as phone line. This capability could be implemented at the data link layer by allocating a modem aggregation bit in the address field and reducing the 6-bit slot address field to 5-bits. This capability could also be implemented at a higher networking layer, such as the application layer, which is represented as payload data at the data link layer. Variations of this design could also be made based on the needs of the service provider.

Referring back to FIG. 6, the remaining fields of a data frame will now be described.

5. Length/Type field: This one-octet field takes one of two meanings, depending on its numeric value. For numerical evaluation, the first octet is the most significant octet of this field. If the value of this field is less than or equal to the value of 63, then the Length/Type field indicates the number of data octets contained in the subsequent data field of the frame (i.e., the Length interpretation). If the value of this field is greater than or equal to 64 decimal (i.e., equal to 0020 hexadecimal), then the Length/Type field indicates the nature of the protocol (i.e., the Type interpretation). The Length and Type interpretations of this field are mutually exclusive. The Length/Type field is transmitted and received with the highest order octet first.

6. Data field: This field contains a sequence of “n” octets (where “n” is an integer). Full data transparency is provided in the sense that any arbitrary sequence of octet values may appear in the data field up to a maximum 63 bytes.

7. FCS field: This field provides a cyclic redundancy check (CRC) used by transmit and receive algorithms to generate a CRC value for the FCS field. The FCS field contains a 2-octet (i.e., 16-bit) CRC value. This value is computed as a function of the contents of all fields of a data frame except the preamble field, SFD field, FCS field, and any extension. The encoding is defined by the following generating polynomial.

$$\begin{matrix}G ( x ) = {x}^{16} + {x}^{14} + {x}^{13} + {x}^{12} + {x}^{10} + {x}^{8} + {x}^{6} + {x}^{4} + {x}^{2} + x + 1 \\ = ( {x}^{3} + {x}^{2} + 1 ) ( {x}^{6} + {x}^{5} + {x}^{2} + x + 1 ) ( {x}^{7} + {x}^{3} + 1 )\end{matrix}$$

Mathematically, the CRC value corresponding to a given data frame is defined by the following procedure:

a. The first 16 bits of the frame are complemented.

b. The n bits of the frame are then considered to be the coefficients of a polynomial M(x) of degree n−1. (The first bit of the destination address field corresponds to the x(n−1) term and the last bit of the data field corresponds to the x⁰ term.)

c. M(x) is multiplied by x¹⁶ and divided by G(x), producing a remainder R(x) of degree≦15.

d. The coefficients of R(x) are considered to be a 16-bit sequence.

e. The bit sequence is complemented and the result is the CRC.

The 16 bits of the CRC value are placed in the frame check sequence field so that the x¹⁵ term is the leftmost bit of the first octet, and the x⁰ term is the right most bit of the last octet. (The bits of the CRC are thus transmitted in the order x¹⁵, x¹⁴, . . . , x¹, x⁰.)

Also according to an exemplary embodiment, an invalid data frame shall be defined as one that meets at least one of the following conditions:

(i) The frame length is inconsistent with a length value specified in the length/type field. If the length/type field contains a type value as defined by the length/type field description previously provided herein, then the frame length is assumed to be consistent with this field and should not be considered an invalid frame on this basis.

(ii) The frame length is not an integral number of octets in length.

(iii) The bits of the incoming frame (exclusive of the FCS field itself) do not generate a CRC value identical to the one received.

As described herein, the present invention provides an architecture and protocol for enabling signal communications between an FTM and an IRD within a dwelling. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus, comprising:
a plurality of inputs for receiving a plurality of bands of television signals;
a plurality of tuning means for converting said bands of television signals to a plurality of intermediate frequencies; and
control means for receiving request commands for said bands of television signals from a plurality of decoding means, each of said decoding means transmitting one of said request commands to said apparatus during a separate time slot.

2. The apparatus of claim 1, wherein said apparatus transmits signals corresponding to said bands of television signals to said decoding means responsive to said request commands.

3. The apparatus of claim 2, wherein said apparatus receives said request commands from said decoding means and transmits said signals corresponding to said bands of television signals to said decoding means via coaxial cable.

4. The apparatus of claim 1, wherein said request commands each indicate at least one of a desired satellite and a desired transponder.

5. The apparatus of claim 1, wherein said control means assigns each of said decoding means its own said separate time slot.

6. The apparatus of claim 1, wherein said apparatus transmits acknowledgement signals to said decoding means responsive to said request commands, and said acknowledge signals indicate frequency bands used by said apparatus to transmit signals corresponding to said bands of television signals to said decoding means.

7. A method for providing television signals via an apparatus, comprising steps of:
receiving a plurality of bands of television signals from a plurality of signal receiving elements;
converting said bands of television signals to a plurality of intermediate frequencies; and
receiving request commands for said bands of television signals from a plurality of decoders, wherein each of said decoders transmits one of said request commands to said apparatus during a separate time slot.

8. The method of claim 7, further comprised of transmitting signals corresponding to said bands of television signals to said decoders responsive to said request commands.

9. The method of claim 8, wherein said apparatus receives said request commands from said decoders and transmits said signals corresponding to said bands of television signals to said decoders via coaxial cable.

10. The method of claim 7, wherein said request commands each indicate at least one of a desired satellite and a desired transponder.

11. The method of claim 7, wherein said apparatus assigns each of said decoders its own said separate time slot.

12. The method of claim 7, wherein said apparatus transmits acknowledgement signals to said decoders responsive to said request commands, and said acknowledge signals indicate frequency bands used by said apparatus to transmit signals corresponding to said bands of television signals to said decoders.

13. A television signal receiver, comprising:
a plurality of inputs operative to receive a plurality of bands of television signals;
a plurality of tuners connected to said inputs and being operative to convert said bands of television signals to a plurality of intermediate frequencies; and
a controller operative to receive request commands for said bands of television signals from a plurality of decoders, each of said decoders transmitting one of said request commands to said television signal receiver during a separate time slot.

14. The television signal receiver of claim 13 wherein said television signal receiver transmits signals corresponding to said bands of television signals to said decoders responsive to said request commands.

15. The television signal receiver of claim 14, wherein said television signal receiver receives said request commands from said decoders and transmits said signals corresponding to said bands of television signals to said decoders via coaxial cable.

16. The television signal receiver of claim 13, wherein said request commands each indicate at least one of a desired satellite and a desired transponder.

17. The television signal receiver of claim 13, wherein said controller assigns each of said decoders its own said separate time slot.

18. The television signal receiver of claim 13, wherein said television signal receiver transmits acknowledgement signals to said decoders responsive to said request commands, and said acknowledge signals indicate frequency bands used by said apparatus to transmit signals corresponding to said bands of television signals to said decoders.
